(19) United States
(12) Patent Application Publication
(10) Pub. No.: US 2008/0106183 A1
(43) Pub. Date: May 8, 2008

(54) Display panel

(76) Inventors: Noriyuki Oroku, Yokohama (JP); Yuuichi Kijima, Chousei (JP); Yuuichi Inoue, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/298,589

(22) Filed: Dec. 12, 2005

(30) Foreign Application Priority Data
Mar. 1, 2005 (JP) 2005-055563

(51) Int. Cl. H01J 1/62

(52) U.S. Cl. 313/496

(57) ABSTRACT

A display panel comprises an anode substrate provided with light emitting members that emit light under irradiation of electron beams, a cathode substrate provided with electron emitting elements, and spacer members arranged inside the display panel. Here, the resistivity between the anode substrate and the spacer members is larger than the resistivity between the cathode substrate and the spacer members.

### BACKGROUND OF THE INVENTION

The present invention relates to a display panel, and particularly to a display panel provided with electron emitters.

Japanese Non-examined Patent Laid-Open No. 10-334832 (Patent Document 1) and Japanese Non-examined Patent Laid-Open No. 9-73869 (Patent Document 2) disclose display panels (FED panels) used for a field emission display. These FED panels are each constructed such that an anode substrate provided with fluorescent elements, each of which emits light when it is irradiated with electron beams, is opposed to a cathode substrate provided with field-emission electron emitters. The inside of each FED panel is kept vacuum, and accordingly, spacers are provided to resist external pressure.

Patent Document 1: Japanese Non-examined Patent Laid-Open No. 10-334832

Patent Document 2: Japanese Non-examined Patent Laid-Open No. 9-73869

### SUMMARY OF THE INVENTION

An FED has neither electrode nor coil for adjusting a path of an electron beam, and thus a path of an electron beam is determined by a vector of the initial energy at the time of emission and acceleration vectors of the accelerating electric field generally given. Thus, in the case where a spacer exists in the neighborhood of a path of an electron beam and equipotential surfaces are not uniform between the spacer and the surrounding accelerating electric field, then the electron beam is bent, and is not correctly incident on the target fluorescent element. In order to correct this, it is not realistic, from the viewpoints of costs and control, to provide additional potential control electrodes separately.

To solve this problem, it is conceivable to use spacers that are difficult to charge up, and to perform surface treatment to realize the secondary-emission yield close to 1. However, “spacers that are difficult to charge up” means spacers having a high conductivity. In that case, leak current owing to the accelerating voltage becomes large, and thus it is difficult to obtain much effect. Further, as the surface treatment for realizing the secondary-emission yield close to 1, application of chrome oxide coating may be considered. However, generally the secondary-emission yield exceeds 1 at the operating potential of a display, and thus complete avoidance of charging up owing to secondary electron emission is impossible.

In the display panels of the above-mentioned Patent Documents 1 and 2, conductive spacers are arranged. However, as described above, it is difficult for these techniques to avoid deflection of electron beams.

An object of the present invention is to provide a technique of reducing deflection of electron beams owing to spacer members arranged in a display panel that has electron emitters.

To solve the above problem, the present invention keeps the conductivities between a spacer member and the upper and lower electrodes (an anode electrode and a cathode electrode) at a suitable ratio. In detail, potential in a spacer member is shifted toward the cathode side from the surrounding equipotential surfaces.

For example, the present invention provides a display panel comprising: a first substrate provided with light emitting members that emit light under irradiation of electron beams; a second substrate provided with electron emitters; and spacer members arranged between said first substrate and said second substrate; wherein: a resistance at connection between said first substrate and said spacer members is larger than a resistance at connection between said second substrate and said spacer members.

Further, the present invention also provides a display panel comprising: a first substrate provided with light emitting members that emit light under irradiation of electron beams; a second substrate provided with electron emitters; and spacer members arranged between said first substrate and said second substrate; wherein: a conductivity of a first adhesion layer between said first substrate and said spacer members is smaller than a conductivity of a second adhesion layer between said second substrate and said spacer members.

The present invention can be applied to a display panel that has electron emitters (electron emitting elements) and spacers inside the panel. For example, the present invention can be applied to a vacuum fluorescent display in which thermoelectrons coming from a cathode are controlled and accelerated by a grid electrode positioned between the cathode and an anode, and hit fluorescent elements (display elements) in the anode to emit light.

### BRIEF DESCRIPTION OF THE DRAWINGS

FIG. 1 is a cross section of a display panel (before lighting) according to the first embodiment of the present invention;

FIG. 2 is a cross section of the display panel (just after lighting) of the first embodiment;

FIG. 3 is a cross section of the display panel (in a stable state) of the first embodiment;

FIG. 4 is a view for explaining a production process of the display panel of the first embodiment;

FIG. 5 is a cross section of a display panel (before lighting) for explaining deflection of an electron beam;

FIG. 6 is a cross section of a display panel (just after lighting) for explaining deflection of an electron beam;

FIG. 7 is a cross section of a display panel (in a stable state) for explaining deflection of an electron beam; and

FIG. 8 is a diagram showing relations between secondary-emission yields for various materials.

### DETAILED DESCRIPTION OF THE PREFERRED EMBODIMENTS

Now, will be described an FED (Field Emission Display) panel to which the present invention is applied.

First, an outline of the FED panel will be described.

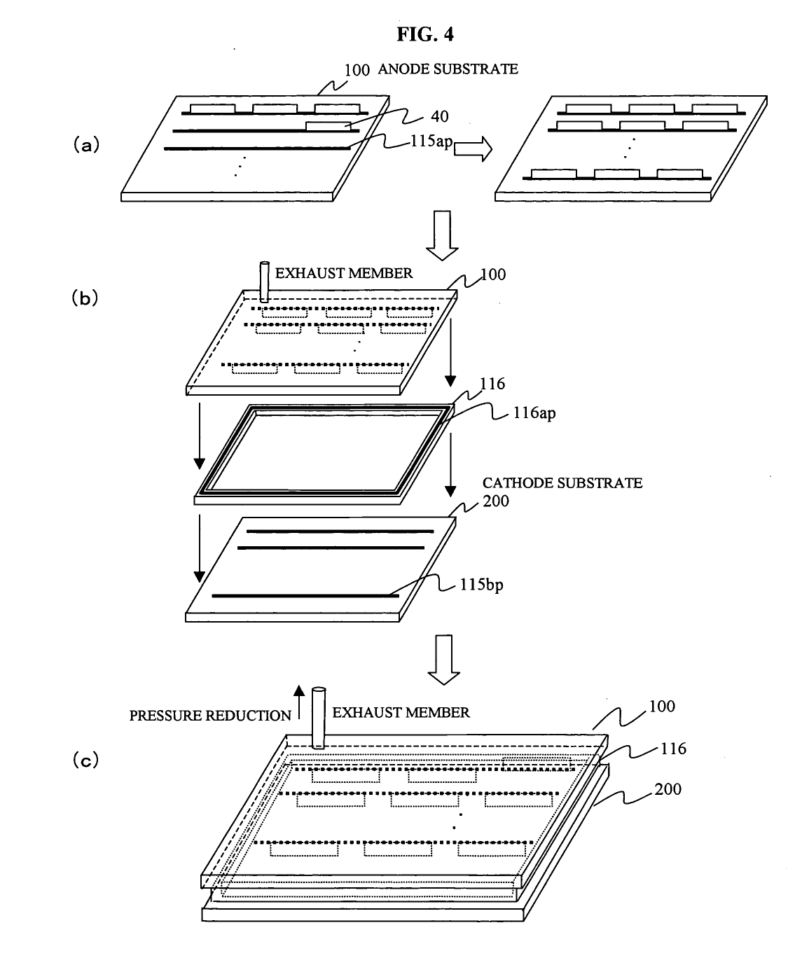

As shown in FIG. 4, the FED panel of the present embodiment is constructed such that an anode substrate 100 and a cathode substrate 200 are opposed to each other, holding a glass frame 116 and spacer members 40 between the substrates 100 and 200.

On the cathode substrate 200, there are arranged signal lines 11 and scanning lines 27 that cross the signal lines 11 on a substrate 10 of an insulating material such as glass.

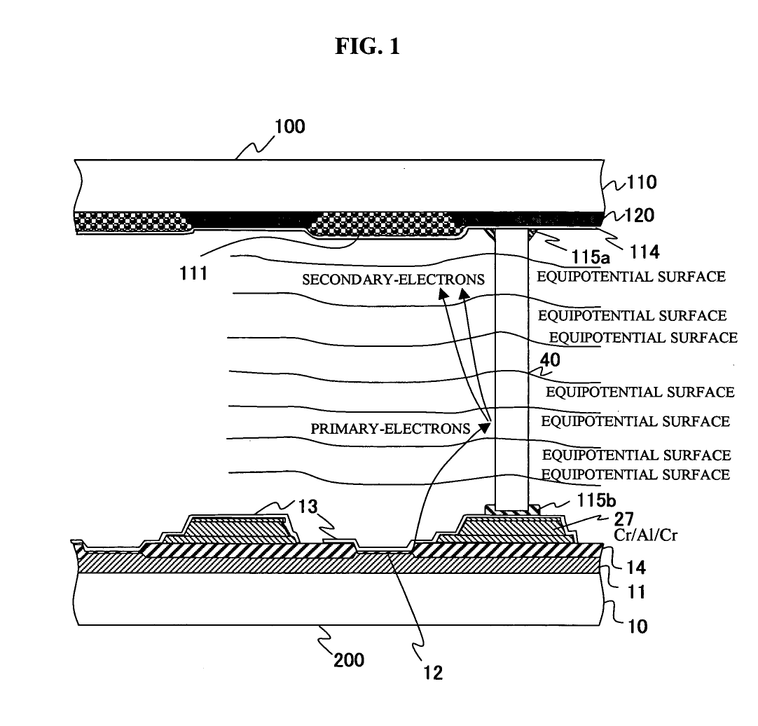

FIG. 1 is a cross section of the FED panel. Here, however, for the sake of easiness of understanding, the anode substrate 100 and the cathode substrate 200 are illustrated being enlarged in the thickness direction. On the other hand, the distance between the anode substrate 100 and the cathode substrate 200 is illustrated on a reduced scale.

As shown in FIG. 1, at a portion where a signal line 11 and a scanning line 27 cross each other, the signal line (a lower electrode) 11, a protective insulating layer 14, the scanning line (an upper bus electrode) 27 and upper electrodes 13 are layered in this order on the substrate 10.

The signal lines 11 are made of Al, Al alloy or the like. Here, the signal lines 11 are made of an Al—Nd alloy having 2 atomic weight % of doped Nd.

The protective insulating layer 14 limits electron emission parts, serving to prevent concentration of the electric field at edges of the lower electrode. Here, the protective insulating layer 14 is made of Al oxide.

The scanning lines 27 are lines for supplying power to the upper electrodes 13. The scanning lines 27 are constructed such that Cr, Al and Cr are layered in this order, for example.

The upper electrodes 13 are each an electrode of an electron emitter. The upper electrodes 13 are constructed such that Ir, Pt and Au are layered in this order, for example.

The electron emitters (cold cathode electron emitters) are arranged in a matrix, each electron emitter being located at a position where a signal line 11 and a scanning line 27 intersect each other. Cold cathode electron emitters are generally classified into a field emission electron emitter (such as a spint electron emitter, a surface-conduction electron emitter and a carbon nanotube electron emitter) and a hot-electron-type electron emitter (such as an MIM (Metal-Insulator-Metal) electron emitter having layers of metal, insulator and metal and an MIS (Metal-Insulator-Semiconductor) electron emitter having layers of metal, insulator and a semiconductor electrode). Any type of electron emitters may be used. MIM electron emitters are disclosed in Japanese Non-examined Patent Laid-Open No. 10-153979, Japanese Non-examined Patent Laid-Open No. 2004-111053, for example.

The FED panel of the present embodiment is provided with MIM electron emitters each consisting of a lower electrode (signal line) 11, insulating film (an electron accelerating layer) 12 and an upper electrode 13. The electron accelerating layer 12 is made of Al oxide.

Operation of an MIM electron emitter will be described simply. A drive voltage Vd is applied between the upper electrode 13 and the lower electrode 11, to have the electric field of about 1-10 MV/cm in the electron accelerating layer 12. Then, electrons in the neighborhood of the Fermi level in the lower electrode 11 transmits the barrier on account of the tunnel effect and are injected into the electron accelerating layer 12, and become hot electrons. These hot electrons are scattered in the electron accelerating layer 12 and the upper electrode 13, and suffer a loss of energy. However, a part of the hot electrons, which have energy larger than the work function φ of the upper electrode 13, are emitted into the vacuum.

The anode substrate 100 is made of a transparent glass plate, for example. On one side of the anode substrate 100, are formed a black matrix 120, fluorescent elements 111, and an anode electrode 114. The anode substrate 100 is arranged such that its surface formed with these elements 120, 111 and 114 faces the surface of the cathode substrate 200 on the side formed with the lines 27.

The glass frame 116, the cathode substrate 200 and the anode substrate 100 are sealed between them with an adhesive such as glass frit so that the pressure inside the substrates is maintained at about 10⁻⁵ Pa.

Further, between the anode substrate 100 and the cathode substrate 200, are placed the spacer members 40 at given intervals to prevent flattening by the external pressure. Each spacer member 40 is adhered and fixed to the electrodes (the anode electrode 114 and the upper electrode 113) on the substrates (the anode substrate 100 and the cathode substrate 200) through adhesive layers 115a and 115b. Details of these adhesive layers 115a and 115b will be described later.

The material of the spacer members 40 is glass, ceramic, a thin plate of natural oxide mineral, or the like. Considering that the spacer members 40 are used under high pressure and in high vacuum, industrially-produced high purity insulating material such as high purity glass, fine ceramic or the like is favorable in order to avoid impurities.

In the present embodiment, the spacer members 40 of a plate shape are used. However, members of another shape such as a stick shape, a cylinder shape, or a cross plate shape may be used.

At the time of operation of the FED panel, ends of the signal lines 11 are connected to a signal line driving circuit as an external circuit. Ends of the scanning line 27 are connected to a scanning line driving circuit as an external circuit. The anode electrode 114 is always applied with an accelerating voltage of about 3-6 kV. Thus, the FED panel operates as a display unit according to the line-sequential driving method, for example.

The FED panel of the present embodiment having the above arrangement is further characterized by a conductivity between a spacer member 40 and each of the substrates (the anode substrate 100 and the cathode substrate 200). Details will be described in the following.

As described above, many electron emitters are arranged on the cathode substrate 200. An electron beam emitted from an electron emitter is accelerated by high voltage applied between a cathode electrode (upper electrode) 13 and the anode electrode 114, and is incident, as a high energy electron beam, on a fluorescent element 111. At that time, strength of displaying of each pixel can be controlled by adjusting quantity of electron beam emission from an electron emitter.

To keep the space where an electron beam passes vacuum, the glass frame 116 exists in the periphery of the display panel, and the anode substrate 100 and the cathode substrate 200 are vacuum-sealed. Further, to obtain a sufficiently large display screen, the spacer members 40 are arranged here and there in the display screen in order to prevent flattening of the display panel by the atmospheric pressure.

Here, it is possible to conceive a method of arranging the spacer members 40 uniformly for all the pixels. However, in the case of a large display, the number of pixels ranges up to millions, and thus it is not realistic to arrange spacers uniformly for all the pixels. Usually, spacer members 40 are not arranged uniformly for all the pixels, but one spacer member is provided for each group of the predetermined number of pixels.

In that case, when an electron beam is emitted from an electron emitter positioned distantly from a spacer member 40, the electron beam moves straight simply, and is incident on the opposite fluorescent element 111 of the anode electrode 114. On the other hand, with respect to an electron emitter in the neighborhood of a spacer member 40, there occurs bending of a path of an electron beam.

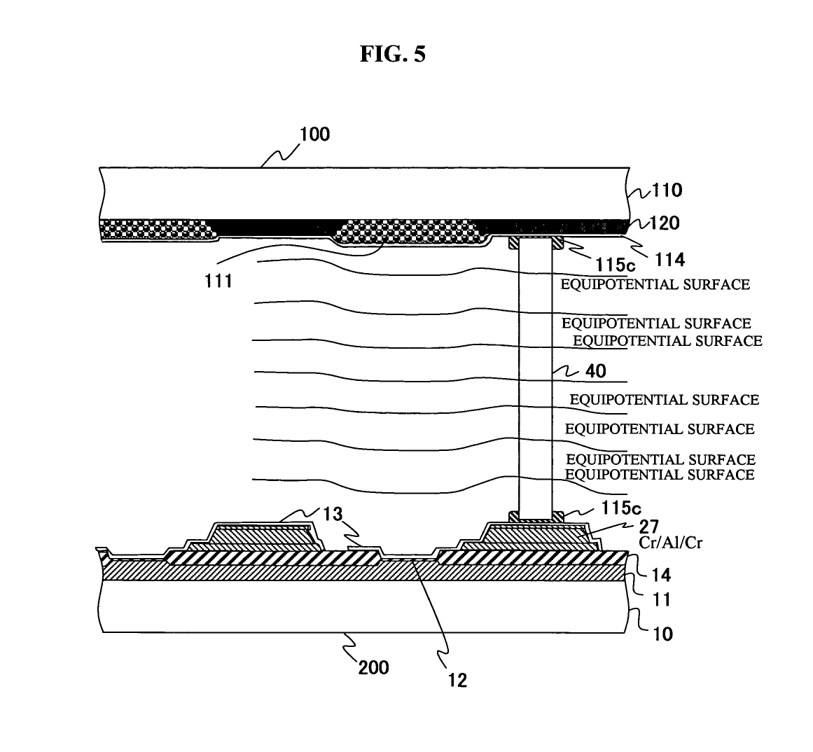

Now, referring to FIGS. 5-7, will be described bending of a path of an electron beam.

FIGS. 5-7 are views for explaining bending of a path of an electron beam in the case where upper and lower electric connections of a spacer member 40 are uniform. Here, the anode substrate 100 side of the spacer member 40 is referred to as the “upper” side, and the cathode substrate 200 side as the “lower” side. Further, in FIGS. 5-7, for the sake of easiness of understanding, the anode substrate 100 and the cathode substrate 200 are illustrated being enlarged in the thickness direction. On the other hand, the thickness of the vacuum space is illustrated being reduced, and fluctuation of equipotential surfaces is shown being enlarged.

FIG. 5 is a cross section schematically showing a state of electric potential between the anode substrate 100 and the cathode substrate 200 before lighting (i.e., before the electron emitters emit electrons) in the case where upper and lower electric connections of a spacer member 40 are uniform. This shows a state in which lighting is not started yet, and the accelerating voltage has been applied already, while the electron emitters are not operating and thus no electron beam is emitted. In other words, this is a state in which the display unit has been turned on while an image is not inputted and thus a black screen is displayed.

In this state, the electric potential distribution in the spacer members 40 generally matches with the equipotential surfaces in the space between the anode substrate 100 and the cathode substrate 200. The equipotential surfaces are uniform except for minute fluctuation caused by the surface structure of the cathode substrate 100 and the surface structure of the anode substrate 200.

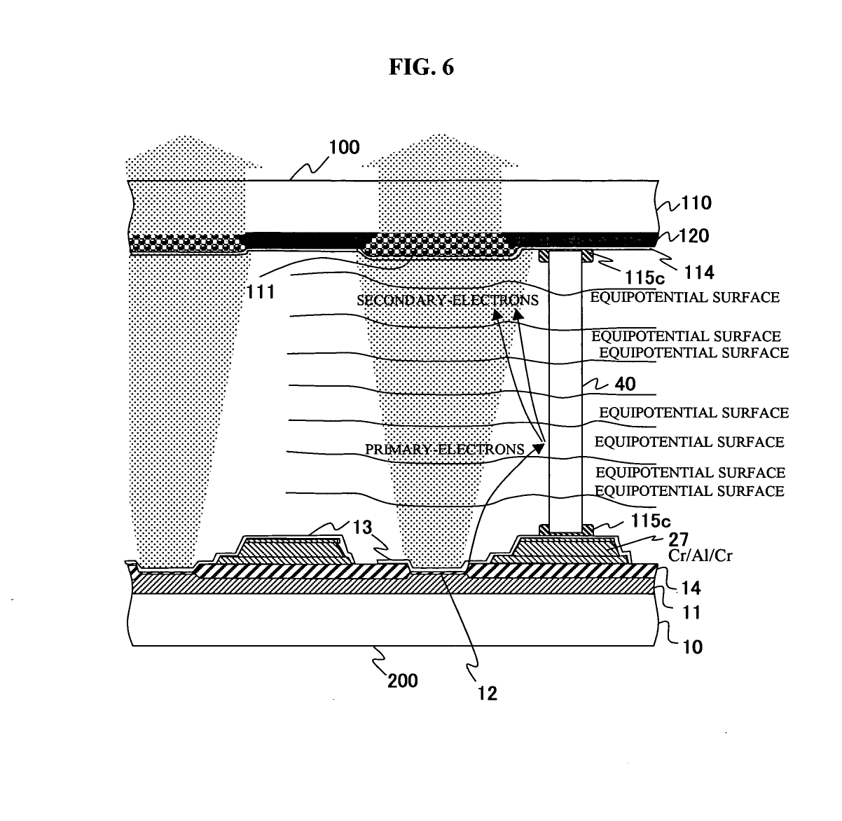

FIG. 6 shows a state just after a start of lighting. Generally, electron beams emitted from the electron emitters go straight, and are incident on the fluorescent elements 111. However, stochastically, a certain number of electron beams are incident on a spacer member 40. At that time, secondary electrons are emitted depending on the energy of the incident electron beams. The ratio of the secondary electrons to the incident electrons is referred to as a secondary-emission yield.

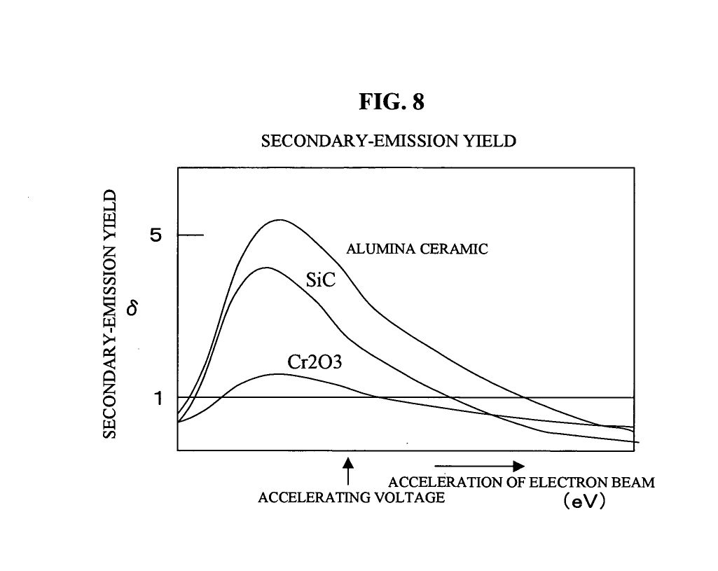

FIG. 8 shows examples of secondary-emission yields for ordinary materials.

In the case where the accelerating voltage is about several thousand volts to ten thousand volts, a secondary-emission yield for an ordinary material exceeds 1. Thus, incident of one electron drives out more than one electron, and the spacer member 40 becomes positively charged. Owing to the conductivity of the spacer member 40, this electron potential is discharged together with a leakage current. However, when the conductivity of the spacer member 40 is too large, an excessive leakage current flows through the spacer member 40 owing to the high accelerating voltage. As a result, the luminous efficiency of the display panel becomes poor. Thus, according to ordinary design, it is not possible to raise the conductivity of the spacer member 40 such that charging due to the secondary electron emission can be disregarded.

Here, it is possible to conceive a method of coating the surface of the spacer member 40 with a material of a lower secondary-emission yield and a method of forming a film of another material on the surface of the spacer member 40. In these methods too, however, the secondary-emission yield exceeds 1 although it closes to 1. As a result, these methods can not avoid distortion of the equipotential surfaces owing to the spacer member 40.

As a result, a path of an electron beam is drawn near to the spacer member 40 little by little. Further, the number of electrons incident on the spacer member 40 becomes larger and thus charging up of the spacer member 40 proceeds more and more.

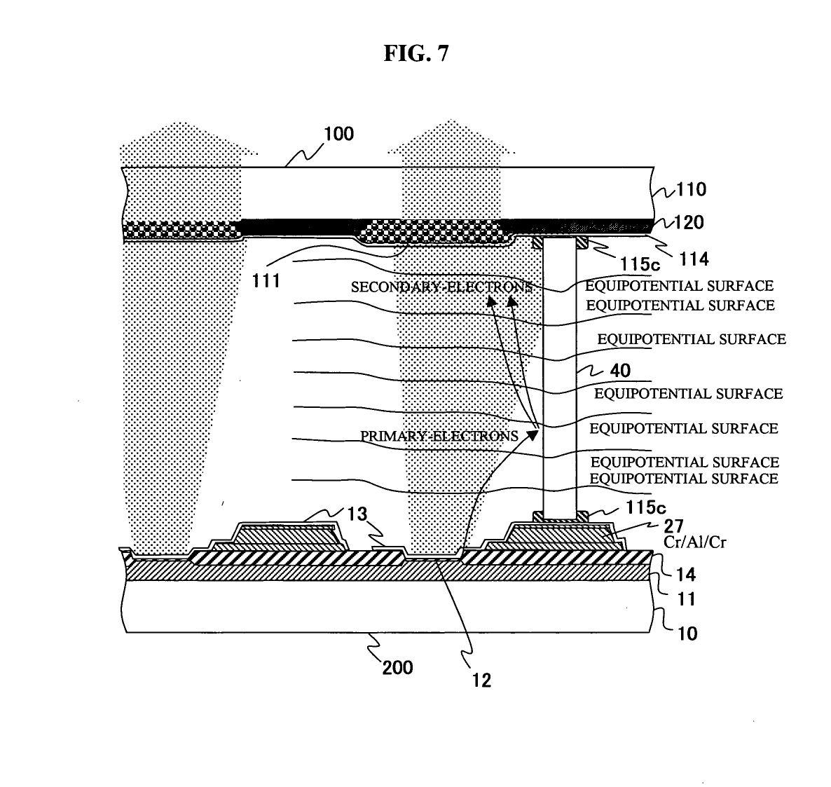

When such a state continues to reach a state where displaying becomes stable, then as shown in FIG. 7, paths of the electron beams show large deflection toward the spacer member 40. Even a part of an area where the density of the electron beams is large is in contact with the spacer member 40. Further, in the fluorescent element 111, there arises a part on which an electron beam is not incident, and thus displaying becomes dark. In an extreme case, the electron beams enter the next fluorescent element, causing distortion of an image or mixing of colors.

Considering these circumstances, the FED panel of the present embodiment has the structure described in the following.

Referring to FIGS. 1-3, the FED panel of the present embodiment will be described.

FIG. 1 is a cross section showing a state of electric potential before lighting.

The FED panel of the present embodiment has different conductivities on the upper and lower sides of each spacer member 40. In detail, each spacer member 40 is fixed to the electrode 114, i.e., the electrode on the anode side and an upper electrode 13, i.e., an electrode on the cathode side through adhesion layers 115a and 115b. At that time, the conductivity of the adhesion layer 115a on the side of the anode substrate 100 is made smaller than the conductivity of the adhesion layer 115b on the side of the cathode substrate 200.

For example, when the resistivity of a spacer member 40 is about 10 GΩ·cm, then the resistivity of the adhesion layer 115a on the anode side is made to be within a range of 5-1000 MΩ·cm, and the resistivity of the adhesion layer 115b on the cathode side is made to be within a range of 2-500 MΩ·cm. Here, however, the resistivity of the adhesion layer 115b on the cathode side is made to be smaller than the resistivity of the adhesion layer 115a on the anode side.

In detail, favorably the resistivity of the adhesion layer 115a on the anode side is made to be about 10 MΩ·cm, and the resistivity of the adhesion layer 115b on the cathode side is made to be half, i.e., about 5 MΩ·cm.

The resistivities of the adhesion layers 115a and 115b can be adjusted by differentiating the kind or the rate of metal included in glass frit used for adhesion.

For example, for adhesion of a spacer member 40 to the anode substrate 100, is used a high-resistance adhesive obtained by adding a small quantity of silver or nickel particles to glass frit (for example, lead glass:Ag=1:4 by weight). On the other hand, for adhesion of a spacer member 40 to the cathode substrate 200, is used a low-resistance adhesive obtained by adding a large quantity of gold particles to glass frit (for example, lead glass:Au=1:1 by weight).

Or, the same kind of metal may be used, while changing its amount contained to differentiate resistivities of the adhesion layers 115a and 115b. Or, the shape of particles to be added may be changed to differentiate the resistivities. For example, flake-shaped particles and grain-shaped particles may be used to differentiate the resistivities.

As a result of the above arrangement, at a non-lighting state, potential in a spacer member 40 is raised in the portion close to the potential on the side of the cathode substrate 200, in comparison with the equipotential surfaces in the surrounding space. And thus the equipotential surfaces shift slightly toward the anode substrate 100. In this state, since an electron beam is not emitted from the electron emitter, an image is not displayed and thus displaying is not affected.

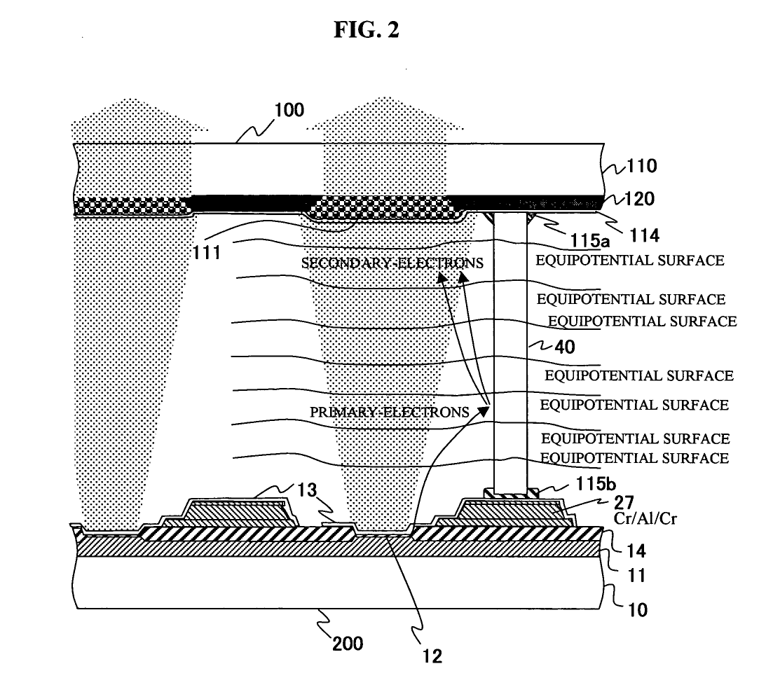

Next, as shown in FIG. 2, when the electron emitter starts to emit electron beams, most of the electron beams are incident on the fluorescent element 111. However, a part of the electron beams are incident on the spacer member 40. Since the equipotential surfaces are inherently in a shifted state, the probability that electron beams are incident on the spacer member 40 is lower in comparison with the above case shown in FIG. 6. As a result, the luminescence intensity of the fluorescent element 111 is scarcely reduced.

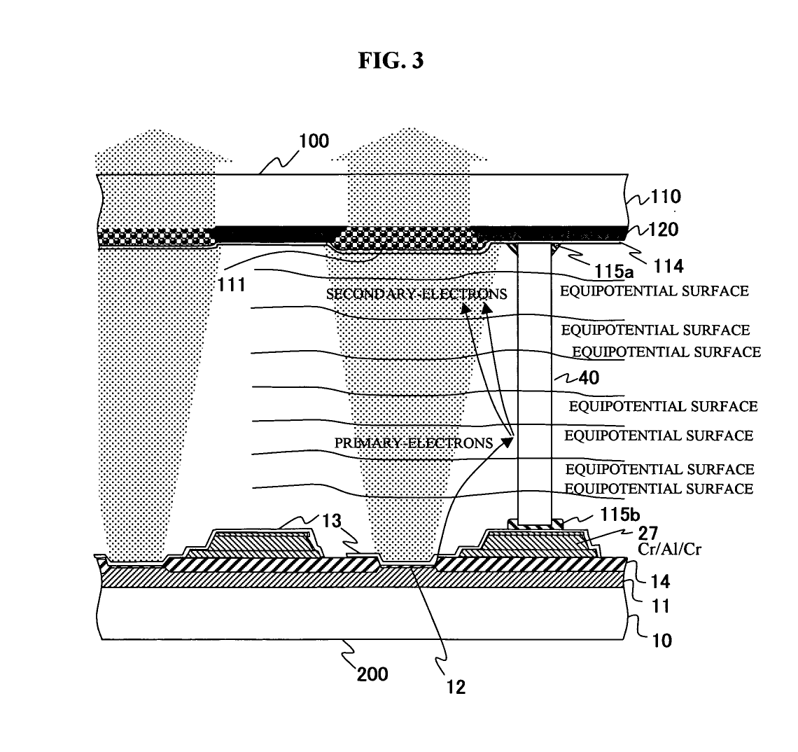

As a result, even when charging of the spacer member 40 proceeds, deflection of the equipotential surfaces is within a small range, as shown in FIG. 3. Thus, the area where the density of the electron beams is large continues to be incident on the fluorescent element 111, and the luminescence intensity of the fluorescent element 111 remains in the level that is by no means inferior to a display pixel that has no spacer in the neighborhood. In other words, it is possible to keep uniformity of a display screen and to obtain a high-quality image display panel.

It is favorable to select degrees of the conductivities such that charging up of the spacers can be cancelled when an image of medium brightness is displayed. Displaying of a bright image tends to cause bending of an electron path, and bending of an electron path is slighter when a darker image is displayed.

The spacer members 40 may be surface-treated with chrome oxide or a mixture of chrome oxide and SiO₂, which can make the secondary-emission yield close to 1. The material and degree of surface treatment can be suitably selected depending on the quantity of electrons emitted from an electron emitter and expected quantity of charging up of a spacer member 40. Namely, it is necessary to select a well-balanced combination of the target quantity of emitted electrons and the effect of canceling the quantity (which is expected from the target quantity of emitted electrons) of charging up of a spacer member 40 by previously differentiating the conductivities. It is a matter of course that fluctuation of bending of an electron path depending on the brightness of a displayed image becomes smaller when the spacers used have the secondary-emission yield closer to 1 and thus bending of an electron path is harder to occur.

Even when the surface-treated spacer members 40 are used, the conductivities of the adhesion layers 115a and 115b can be suitably selected depending on the secondary-emission yield of the spacer members 40.

Next, a production process of the FED having the above-described construction will be described referring to FIG. 4.

Here, it is assumed that the black matrix 120, the fluorescent elements 111, the anode electrode 111 and the like have been formed on the anode substrate 100. Further, it is assumed that desired electron emitters and electric circuits are formed on the cathode substrate 200 using techniques of photoengraving, printing and the like, for example. Further, it is assumed that the spacer members 40, the glass frame 116, an exhaust part, and the like are prepared by previously assembling and cleaning.

As shown in FIG. 4 (Step (a)), frit paste 115ap is applied by printing or by a dispenser to places where the spacer members 40 are to be erected on the anode electrode 114 of the anode substrate 100. The frit paste 115ap used for this purpose is, for example, glass frit mixed with several %—25% silver particles by volume-ratio, and the mixture is kneaded with a solvent and a binding material to obtain a paste.

Then, the spacer members 40 are pushed against and fixed to the frit paste 115ap, and thereafter baked tentatively.

On the other hand, on the cathode substrate 200, frit paste 115bp is applied by printing or by a dispenser to places in which the spacer members 40 are to be located. The frit paste 115bp used for this purpose is, for example, glass frit mixed with 20-100% gold particles by volume-ratio, and the mixture is kneaded with a solvent and a binding material to obtain a paste. After applying the paste, the cathode substrate 200 is dried and baked tentatively.

Then, as shown in FIG. 4 (Step (b)), the anode substrate 100 on which the spacer members 40 are arranged and the cathode substrate 200 are combined, putting the glass frame 116 (on which the glass frit 116ap has been applied and dried) between them. Then, regular baking is performed to fix the whole.

Further, as shown in FIG. 4 (Step (c)), using an exhaust member attached to the anode substrate 100, the inside is evacuated and then the exhaust pipe is sealed and getter flashing is performed to prevent vacuum deterioration. Thus, the FED panel is produced.

Hereinabove, the FED panel of the present embodiment and its production method have been described.

According to the above embodiment, it is possible to keep the ratio of the conductivity on the upper side of a spacer member to the conductivity on the lower side at the suitable ratio. As a result, it is possible to shift the potential in the spacer member from the equipotential surfaces toward the cathode side at the non-lighting time. And, it is possible to cancel the tendency of the potential in the spacer member to shift toward the anode side owing to the secondary electron emission during lighting. As a result, it is possible to prevent discrepancy of a path of an electron beam accompanying charging up of a spacer member. This can not be attained by a conventional oxide spacer or a non-conductive spacer coated with conductive material.

Further, the spacer members 40 are stably supported by both the anode substrate 100 and the cathode substrate 200 through the adhesion layers. Accordingly, the supporting strength is increased in comparison with the case where each spacer member 40 is adhered and supported only at one end part.

Further, since the adhesion layer 115a on the side of the anode substrate 100 can have a lower resistivity, the frit can include a large quantity of a glass component. In the production process of the display panel, the spacer members 40 are not adhered to the anode substrate 100 and the cathode substrate 200 at the same time. It is easier that the spacer members 40 are first adhered to one substrate and thereafter to the other substrate as shown in FIG. 4. For supporting, even temporarily, each of the spacer members 40 at one end, sufficient adhesive strength is required. In the FED panel of the present embodiment, the adhesion layer 115a on the side of the anode substrate 100 can include a large quantity of glass to obtain sufficient adhesive strength.

The present invention is not limited to the above embodiment, and can be modified variously within the scope of the invention.

For example, in the above embodiment, composition of frit is adjusted by using different material, i.e., gold or silver and by differentiating amounts of the added material, to adjust the conductivity. However, it is possible also to add silver particles commonly for both adhesive layers to adjust the conductivity only by differentiating the amounts of the silver particles added. Further, as the conductive material to be added, may be used a precious metal such as indium or platinum.

Further, instead of adding expensive precious metal to frit, the conductivity may be adjusted by adding a base metal such as nickel particles or an conductive inorganic material such as SiC.

Further, it is possible to give conductivity to glass by adding particles or fiber of conductive ceramic to frit. For example, the resistivity of an adhesive layer becomes higher when fine particles of silicon carbide and whiskers of silicon carbide are added, while the resistivity becomes lower when whiskers of silicon carbide are added. Thus, this combination may be used. In this case, it is possible to suppress reaction with glass in comparison with the case of adding metal, and as a result this brings an advantage of reducing fluctuation of conductivity depending on baking temperatures. Further, instead of frit, may be used various adhesive materials (pates) other than glass, for example an adhesive material having an organic compound or an inorganic compound (for example, ceramic) as its base.

Further, it is possible to change potential in a spacer material 40 not only by differentiating the materials of the adhesion layers, but also by selecting materials for the electrodes and by performing surface treatment of the electrodes.

For example, a high resistivity electrode material such as iron or nickel may be used for the anode electrode. The tentative baking (e.g. pre-baking) as the process of connecting this anode electrode and the spacer members 40 is performed under an oxidizing atmosphere. As the electrodes on the cathode substrate, low resistivity electrodes of aluminum may be used. The regular baking as the process of connecting these cathode electrodes and the spacer members 40 is performed under a reducing atmosphere. Thus, it is possible to differentiate conductivities with respect to a spacer member 40 by selecting the electrode materials and by differentiating the surface oxidation states. In that case, it is possible to obtain the same effect without differentiating frit materials, and thus advantageously cheap frit material can be used.

The present invention can be applied to a display panel that has electron emitters (electron emitting elements) and spacers inside the panel. For example, the present invention can be applied to a vacuum fluorescent display (VFD) in which thermoelectrons coming from a cathode are controlled and accelerated by a grid electrode positioned between the cathode and an anode, and hit fluorescent elements (display elements) in the anode to emit light.

1. A display panel comprising:
a first substrate provided with light emitting members that emit light under irradiation of electron beams;
a second substrate provided with electron emitters; and
spacer members arranged between said first substrate and said second substrate;
wherein:
a resistance at connection between said first substrate and said spacer members is larger than a resistance at connection between said second substrate and said spacer members.

2. A display panel comprising:
a first substrate provided with light emitting members that emit light under irradiation of electron beams;
a second substrate provided with electron emitters; and
spacer members arranged between said first substrate and said second substrate;
wherein:
a conductivity of a first adhesion layer between said first substrate and said spacer members is smaller than a conductivity of a second adhesion layer between said second substrate and said spacer members.

3. A display panel according to claim 2, wherein:
said first and second adhesion layers are each a mixture including a nonconductive material and a conductive material; and
said first adhesion layer is different from said second adhesion layer in a ratio of the conductive material included.

4. A display panel according to claim 2, wherein:
said first and second adhesion layers are each a mixture including a nonconductive material and a conductive material; and
said first adhesion layer is different from said second adhesion layer in a kind of conductive material included.

5. A display panel according to claim 2, wherein:
said first and second adhesion layers are each a mixture including a nonconductive material and a conductive material; and
said first adhesion layer is different from said second adhesion layer in a shape of the conductive material included.

6. A display panel according to one of claims 3-5, wherein:
said non-conductive material is glass.
